(19) United States
(12) Patent Application Publication
(10) Pub. No.: US 2025/0222863 A1
(43) Pub. Date: Jul. 10, 2025

(54) LAMP SYSTEM

(71) Applicant: HYUNDAI MOBIS CO., LTD., Seoul (KR)

(72) Inventor: Myeong Je KIM, Seoul (KR)

(73) Assignee: HYUNDAI MOBIS CO., LTD., Seoul (KR)

(21) Appl. No.: 18/825,102

(22) Filed: Sep. 5, 2024

(30) Foreign Application Priority Data
Jan. 4, 2024 (KR) 10-2024-0001427

(51) Int. Cl. B60Q 5/00; B60R 11/02; F21S 43/00; F21V 33/00; H04R 1/02; H04R 3/04

(52) U.S. Cl. CPC B60Q 5/008; B60R 11/0217; F21S 43/601; F21V 33/0056; H04R 1/028; H04R 3/04; H04R 2499/13

(57) ABSTRACT

A lamp system disposed in a moving object includes an audio module outputting a sound; a light source module including a light source and outputting an image; and a control module controlling an output of the light source module and the audio module based on a control signal of the lamp system, wherein the control module controls the output of the light source module and the audio module by transmitting an image signal and an audio signal, which are synchronized with each other, based on the control signal.

### CROSS-REFERENCE TO RELATED APPLICATIONS

This application claims priority under 35 U.S.C. § 119 to Korean Patent Application No. 10-2024-0001427, filed on Jan. 4, 2024, in the Korean Intellectual Property Office, the disclosure of which is incorporated herein by reference in its entirety.

### TECHNICAL FIELD

The following disclosure relates to a lamp system, and more particularly, to a sound-linked lamp system disposed on a moving object.

### BACKGROUND

A virtual engine sound system (VESS) is a system to solve a problem of a driver of an eco-friendly moving object such as an electric vehicle having difficulty in recognizing a pedestrian and a moving object around the vehicle due to its low noise. The VESS may assist in detecting the approach of the moving object in a surrounding environment by emitting an artificially generated sound when the moving object is moved.

In addition, the road surface information display related laws were enacted in 2022, which include four symbols for driver warnings. In detail, the four symbols include symbols that include the meaning of road surface caution (slip), collision caution, wrong path caution, and lane caution.

However, communication between the pedestrian and the driver may be difficult when using only visual information displayed by an existing communication lamp. When comparing information capacity of each human sensory organ, it may be seen that the highest senses are vision and hearing, which respectively account for approximately 83% and 11%. Therefore, there is a need for a communication lamp that may enhance information transmission by synchronizing an audio signal with an image signal output from the existing communication lamp and transmitting these signals together.

### SUMMARY

An embodiment of the present disclosure is directed to providing a lamp system that may output a sound.

In one general aspect, provided is a lamp system disposed in a moving object, the system including: an audio module outputting a sound; a light source module including at least one light source and outputting an image; and a control module controlling the output of the light source module and the audio module based on a control signal of the lamp system, wherein the control module controls the output of the light source module and the audio module by transmitting an image signal and an audio signal, which are synchronized with each other, based on the control signal.

The system, in which the audio module is disposed outside the moving object, may further include an external interface transmitting the audio signal to the audio module.

The control module transmits a start command to the audio module before outputting the image signal, and controls the light source module and the audio module to respectively output the image and the sound when receiving an approval command from the audio module.

The light source module may further include at least one lens, and a piezoelectric element disposed on a surface of the lens and generating vibration based on the audio signal.

The system may further include a memory module storing image data and audio data to be output respectively through the light source module and the audio module.

The image data and the audio data may have the same size.

The control module may control the output of the light source module and the audio module by further transmitting control commands respectively to the light source module and the audio module based on the control signals, and the control commands may have the same format size.

The control module may control the output of the light source module and the audio module respectively based on a pre-stored mapping table when the image data and the audio data have sizes different from each other, and control a file including the audio data that is required to be executed simultaneously when executing a file including the image data to be executed sequentially based on the mapping table.

The audio data may include a synchronization signal.

The audio module may further include a plurality of buffers through which multiple sounds are output simultaneously.

The audio module may further include an amplifier (AMP) connected to each of the plurality of buffers and changing each sound volume.

The audio module may modulate sound frequencies for the multiple output sounds to have different frequency bands.

The control module may receive temperature data from one of an internal temperature sensor included in the light source module and the moving object, and control the output of the audio module based on the received temperature data.

The light source module may include the plurality of light sources, and the control module may control the output of the audio module to be increased based on the number of the activated plurality of light sources when this number is less than a pre-stored reference number.

The control module may control the output of the audio module to be increased when the received temperature data is lower than a pre-stored reference temperature.

The audio module may further include a filter that corrects a frequency of an audio signal input the audio module.

Other features and aspects will be apparent from the following detailed description, the drawings, and the claims.

### BRIEF DESCRIPTION OF THE DRAWINGS

FIG. 1 is a schematic diagram showing a lamp system according to the embodiment of the present disclosure.

FIG. 2 is a schematic diagram showing a sound output process according to another embodiment of the present disclosure.

FIG. 3 is a schematic diagram showing a sound output process different from that shown in FIG. 2.

FIG. 4 is a schematic diagram showing a lamp system according to another embodiment of the present disclosure.

FIG. 5 is a table showing a mapping table according to another embodiment of the present disclosure.

FIG. 6 is a schematic diagram showing a synchronization method according to another embodiment of the present disclosure.

FIG. 7 is a schematic diagram showing a method for simultaneously playing a virtual engine sound and an information display voice according to another embodiment of the present disclosure.

FIG. 8 is a schematic diagram showing a method for simultaneously playing the virtual engine sound and the information display voice according to an embodiment different from that shown in FIG. 7.

FIG. 9 is a graph showing a correlation between the temperature and modulus of a polycarbonate (PC).

FIG. 10 is a schematic diagram showing a method for adjusting sound output of the lamp system according to another embodiment of the present disclosure.

FIG. 11 is a schematic diagram showing a method for adjusting the sound output of a lamp system according to an embodiment different from that shown in FIG. 10.

### DETAILED DESCRIPTION

In order to describe the present disclosure, operational advantages of the present disclosure, and objects accomplished by embodiments of the present disclosure, the embodiments of the present disclosure are hereinafter exemplified and described with reference to the accompanying drawings.

First, terms used in this application are used only to describe specific embodiments rather than limiting the present disclosure, and a term of a singular number may include its plural number unless explicitly indicated otherwise in the context. In addition, it is to be understood that terms “include”, “have”, and the like used in this application specify the existence of features, numerals, steps, operations, components, parts, or combinations thereof, which are mentioned in the specification, and do not preclude the existence or addition of one or more other features, numerals, steps, operations, components, parts, or combinations thereof.

Omitted is a description of a case where it is decided that the detailed description of the known configuration or function related to the present disclosure may obscure the gist of the present disclosure.

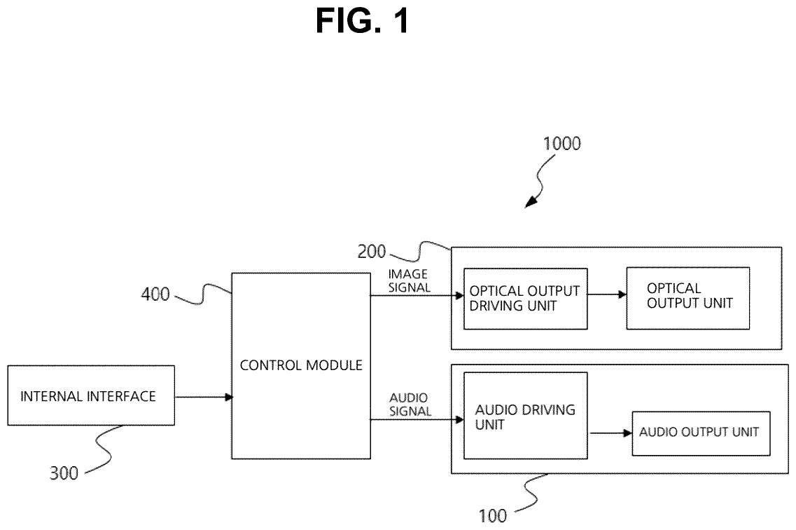

FIG. 1 is a schematic diagram showing a lamp system according to the embodiment of the present disclosure.

As shown in FIG. 1, a lamp system 1000 disposed in a moving object, according to an embodiment of the present disclosure, may include an audio module 100, a light source module 200, an internal interface 300, and a control module 400. In the present disclosure, “the moving object” indicates any type of independently movable device, including an automobile, a mobile robot, an autonomous moving object, an electric scooter, a bicycle, a Segway, a hovercraft, and other means of transportation, and is not limited thereto.

The audio module 100 may output a sound, and may include an audio driving unit generating power and an audio output unit outputting the sound.

The light source module 200 may include at least one light source 210 and output an image, and include an optical output driving unit generating power and an optical output unit generating a beam and outputs the image.

The internal interface 300 may receive at least one of a control signal of the lamp system 1000 and moving object information from the moving object.

The control module 400 may control an output or outputs of the light source module 200 and the audio module 100 based on the output (control signal) of the internal interface 300. The output or outputs may include the sound and image respectively output from the audio module 100 and the light source module 200.

In detail, the control module 400 may transmit an image signal and an audio signal, which are synchronized with each other, based on the output of the internal interface 300 respectively to the light source module 200 and the audio module 100, thereby respectively controlling the output of the light source module 200 and the audio module 100.

In more detail, the control module 400 may transmit the audio signal synchronized with the audio signal when outputting the audio signal, thereby enhancing information transmission.

Meanwhile, the audio module 100 may be disposed inside or outside the moving object.

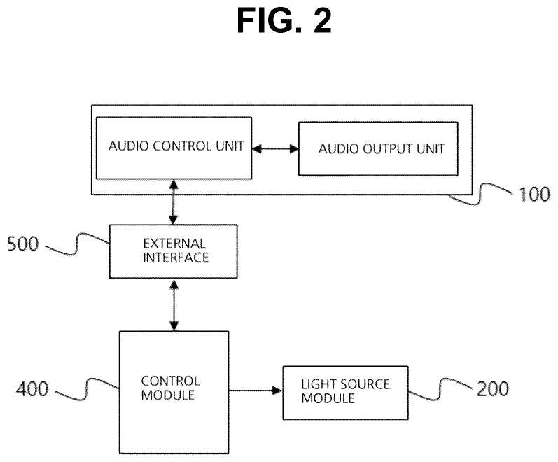

FIG. 2 is a schematic diagram showing a sound output process according to another embodiment of the present disclosure.

As shown in FIG. 2, when the audio module 100 is disposed outside the moving object, the lamp system 1000 according to another embodiment of the present disclosure may further include an external interface 500.

In detail, the external interface 500 may include a serializer & deserializer (SERDES) for long-distance transmission of the signal, and transmit the audio signal to the audio module 100 disposed outside the moving object by using the SERDES.

Here, the control module 400 may transmit a start command to the audio module 100 before outputting the image signal. In addition, the control module 400 may receive an approval command from the audio module 100, and control the light source module 200 and the audio module 100 to respectively output the image and audio when receiving the approval command. Here, the audio module 100 may transmit the approval command, and then output the audio based on a time delay because the audio module 100 identifies in advance the time delay at which the image is output from the light source module 200.

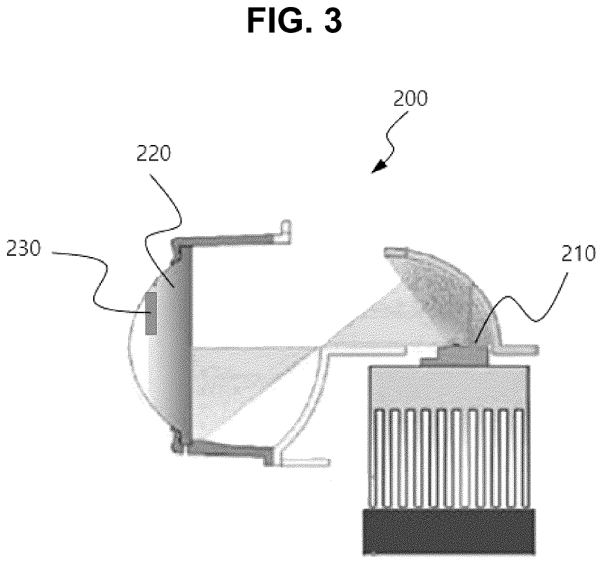

FIG. 3 is a schematic diagram showing a sound output process different from that shown in FIG. 2.

As shown in FIG. 3, the light source module 200 may further include at least one lens 220 and a piezoelectric element 230.

The piezoelectric element 230 may be disposed on a surface of the lens 220, and generate vibration based on the audio signal.

In detail, the lamp system 1000 is unable to generate an opening hole required for installing a speaker because light intensity is weakened due to a water droplet when moisture occurs therein. Therefore, in order to output the sound in a sealed structure that is blocked from the outside, the lamp system 1000 may generate the sound by vibration caused by contraction and expansion of the piezoelectric element 230 by disposing the piezoelectric element 230 on the lens 220. In this case, the control module 400 may control both the image signal and the audio signal, and thus simultaneously output the audio and the image.

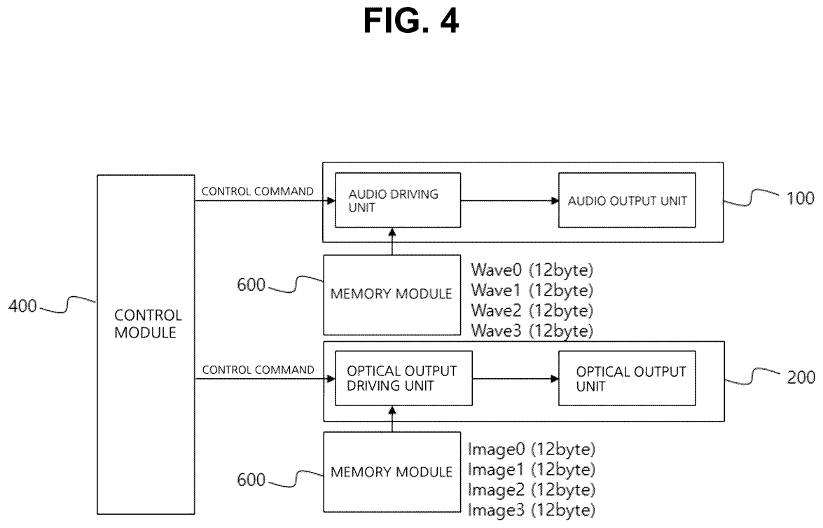

FIG. 4 is a schematic diagram showing a lamp system according to another embodiment of the present disclosure.

As shown in FIG. 4, the lamp system according to another embodiment of the present disclosure may further include a memory module 600.

The memory module 600 may store image data and audio data to be output respectively through the light source module 200 and the audio module 100.

Here, it is preferable that the image data and the audio data have the same size, which may enable the two data to be automatically synchronized with each other when these two data simultaneously start.

In addition, the control module 400 may further transmit control commands respectively to the light source module 200 and the audio module 100 based on the output of the internal interface 300. In this way, the control module 400 may control the output of the light source module 200 and the audio module 100. Here, it is preferable that the control commands have the same format size. As a result, the control module 400 may synchronize the audio and the image and output the same together.

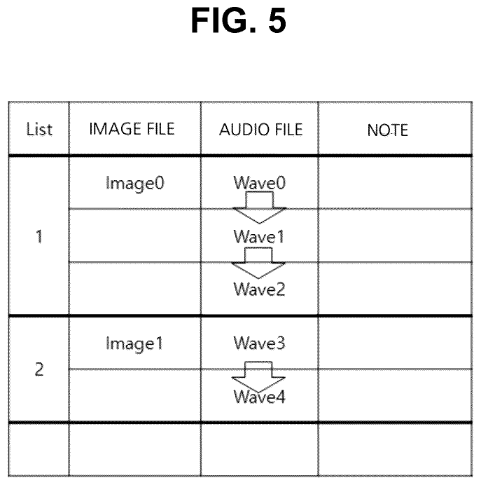

FIG. 5 is a table showing a mapping table according to another embodiment of the present disclosure.

Meanwhile, the control module 400 may control the output of the light source module 200 and the audio module 100 respectively based on the pre-stored mapping table when the image data and the audio data have sizes different from each other.

The mapping table may map a file including the audio data that is required to be executed together when executing a file including the image data, and the control module 400 may control the corresponding audio file to be executed sequentially when executing one image file based on the mapping table.

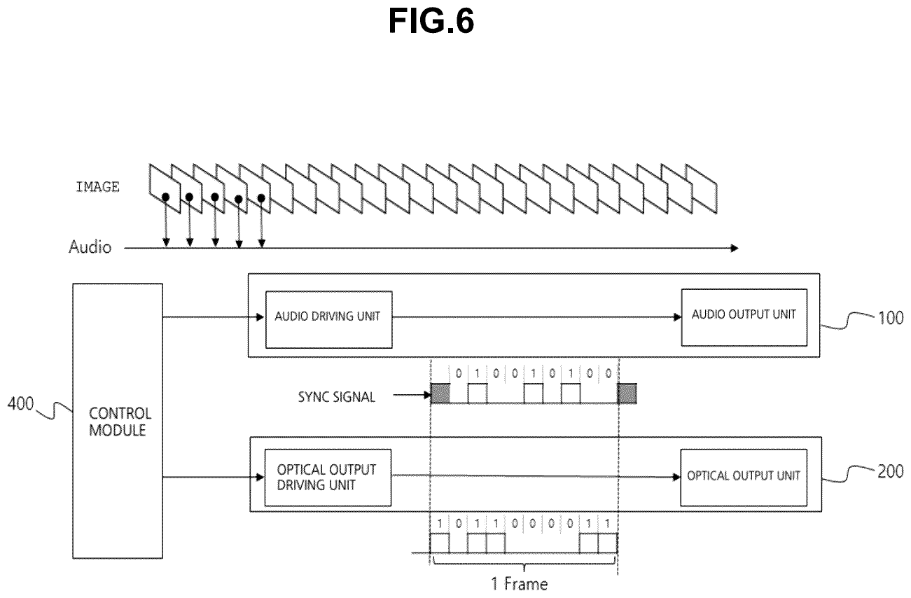

FIG. 6 is a schematic diagram showing a synchronization method according to another embodiment of the present disclosure.

As shown in FIG. 6, the audio data may include a synchronization signal.

In detail, the audio data may be synchronized with the image data in a frame unit.

In more detail, the audio data and the image data may be synchronized with each other by the synchronization signal that may distinguish the audio data by a frame timing unit of the image data.

Hereinafter, the description describes a method for simultaneously playing a plurality of sounds, i.e., a virtual engine sound and an information display voice.

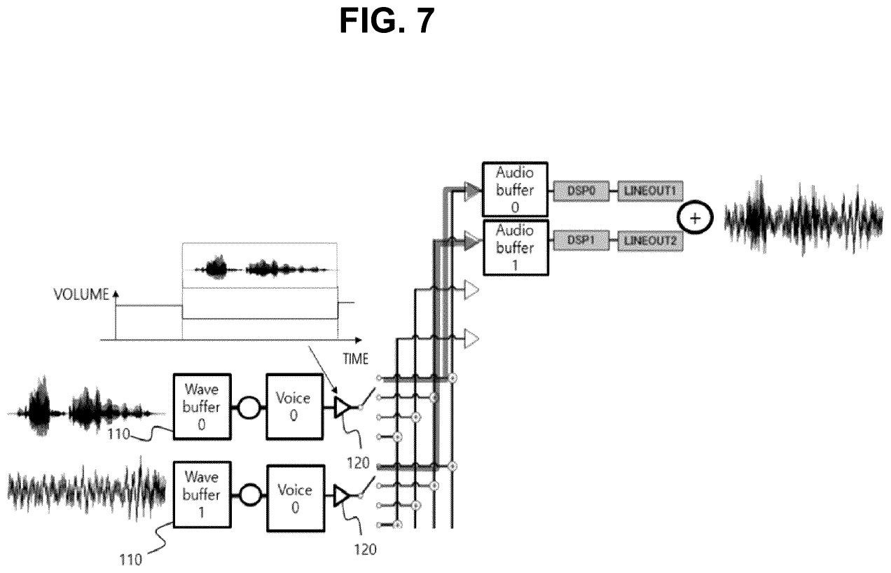

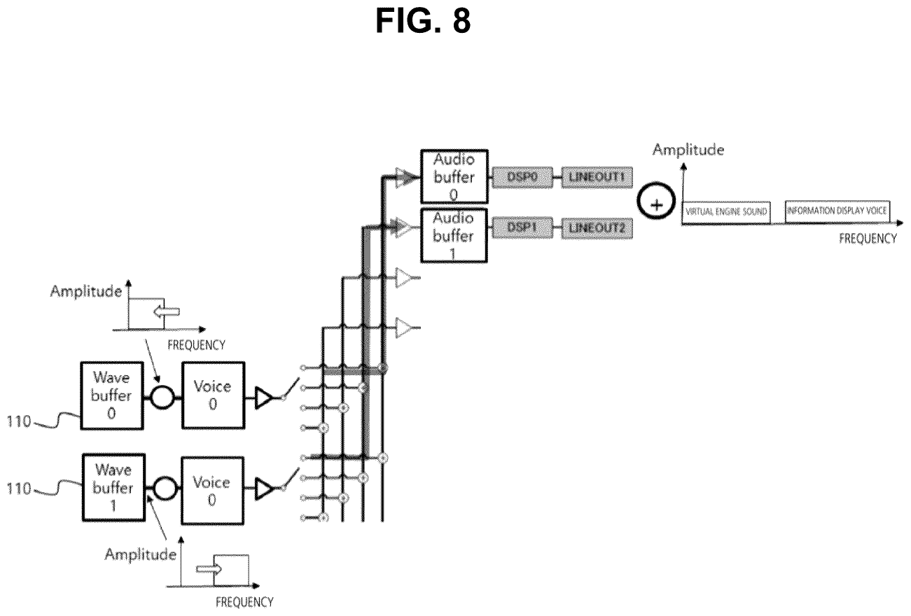

FIG. 7 is a schematic diagram showing a method for simultaneously playing the virtual engine sound and the information display voice according to another embodiment of the present disclosure; and FIG. 8 is a schematic diagram showing a method for simultaneously playing the virtual engine sound and the information display voice according to an embodiment different from that shown in FIG. 7.

As shown in FIG. 7, the lamp system according to another embodiment of the present disclosure may further include buffers 110.

The plurality of buffers 110 may be provided to thus simultaneously output the plurality of sounds respectively through the buffers 110.

For example, a situation may occur where the information display voice is required to be played while the virtual engine sound is output. Here, while the information display voice is to be played, a volume of the virtual engine sound may be lower to thus relatively highlight the information display voice. To this end, the audio module 100 may include the plurality of buffers 110 to simultaneously play two or more sounds. Here, the audio module 100 may further include an amplifier (AMP) 120, and the amplifier 120 may be connected to each of the plurality of buffers 110 and individually change each sound volume.

Meanwhile, as shown in FIG. 8, the audio module 100 may simultaneously play the virtual engine sound and the information display voice by modulating their frequencies.

In detail, the audio module 100 may modulate the sound frequencies for the multiple output sounds to have different frequency bands.

In more detail, the information display voice is required to be delivered as a clear and distinct voice, and it is thus preferable that the audio module 100 modulates the information display voice into a high frequency and output the same. On the other hand, the virtual engine sound is required to be a grand sound rather than the clear sound, and it is thus preferable that the audio module 100 modulates the virtual engine sound to a low frequency and output the same.

The audio module 100 may output the sounds without interference by separating frequency ranges of the two sounds in this way.

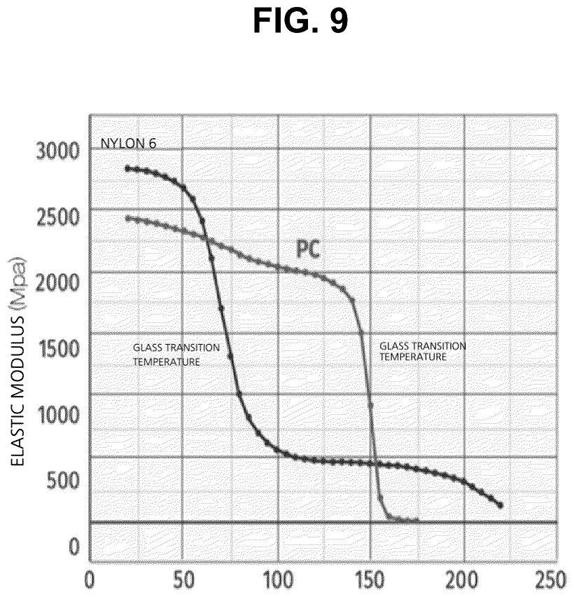

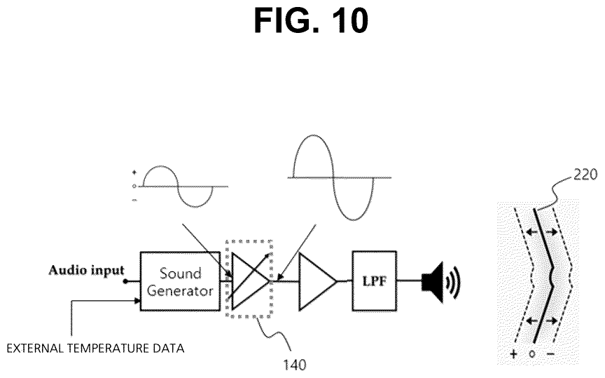

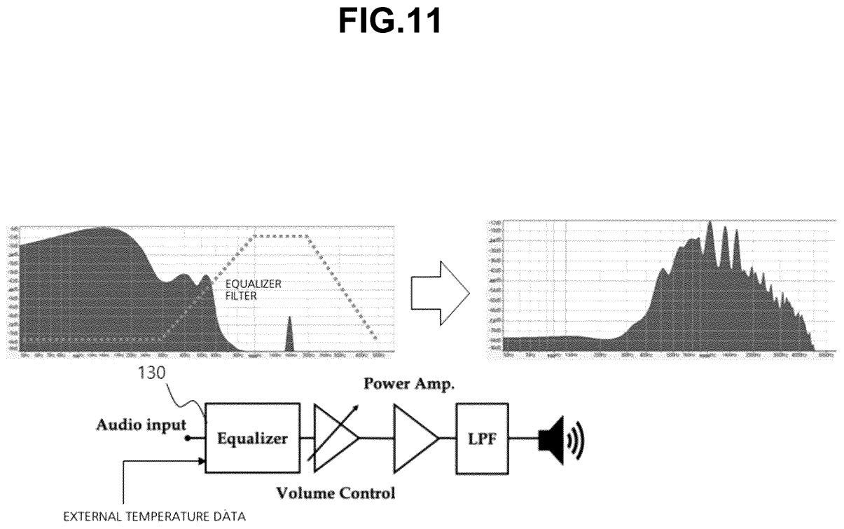

FIG. 9 is a graph showing a correlation between the temperature and modulus of a polycarbonate (PC); FIG. 10 is a schematic diagram showing a method for adjusting the sound output of the lamp system according to another embodiment of the present disclosure; and FIG. 11 is a schematic diagram showing a method for adjusting the sound output of a lamp system according to an embodiment different from that shown in FIG. 10.

As shown in FIG. 9, polycarbonate (PC), which is widely used as a main material of the lens 220 has a rigidity that is changed based on its temperature. In detail, polycarbonate has its rigidity increased when the temperature is low and reduced when the temperature is high. Therefore, when having the low temperature, the lens 220 may have a weaker vibration force because its rigidity is relatively stronger compared to when the temperature is high. In particular, a low-frequency vibration requires a lot of energy because its wavelength is long, whereas a vibration force may be weaker compared to high-frequency vibration in a material having a strong rigidity. Therefore, it is necessary to control the sound based on the temperature.

Accordingly, the control module 400 may receive temperature data from one of an internal temperature sensor included in the light source module 200 and the moving object. In addition, the control module 400 may control the output of the audio module 100 based on the received temperature data. Here, the internal interface 300 may receive the temperature data and provide the same to the control module 400.

In detail, the control module 400 may control the output of the audio module 100 to be increased when the received temperature data is lower than a pre-stored reference temperature.

In more detail, as shown in FIG. 10, the audio module 100 may further include a volume controller 140, and the audio module 100 may amplify the output of the audio module 100 by using this volume controller 140 and vibrate the lens 220 while having a stronger intensity as much as an amplified signal.

In addition, as shown in FIG. 11, the audio module 100 may further include a filter 130 that corrects a frequency of the input audio signal.

In winter or when an external temperature is low, a sound pressure may be weak due to the strong rigidity of the lens 220. In particular, due to the strong rigidity of the lens 220, a low frequency band having a long wavelength may have a reduced volume. Therefore, in the low temperature situation, a filter that emphasizes a high frequency band may preferably be used to output the sound by mainly using the high frequency band. The high-frequency vibration may have a wavelength shorter than that of the low frequency, thus reducing the vibration force less even when an outer lens has the strong rigidity.

In addition, when the lamp system 1000 is turned on, the temperature of the lens 220 may be increased due to heat generated from the light source 210. As the temperature is increased, the lens 220 may become flexible and smooth vibration may be generated in the lens 220. Therefore, the control module 400 may change and control the sound volume and the filter because the sound pressure may be increased compared to when at the low temperature. Here, the moving object may estimate the temperature of the lens 220 by using its external temperature sensor or internal temperature sensor, and the control module 400, which receives the estimated temperature, may change the sound volume and the filter based thereon.

In detail, the light source module 200 may include the plurality of light sources 210. Therefore, the temperature increase of the lens 220 may depend on the number of activated light sources 210.

In more detail, a temperature of a general headlamp may be increased as more functions are activated, and a temperature of the communication lamp may be increased as more pixels are turned on in white. Therefore, the control module 400 may detect the number or function of the activated plurality of light sources 210, and perform the control the output of the audio module 100 to be increased using the method described above when the number or function of the plurality of light sources 210 is less than the pre-stored reference number.

As set forth above, the lamp system according to the various embodiments of the present disclosure may output not only the image but also the sound from the communication lamp, thereby enhancing the information recognition ability of the pedestrian and the driver.

Although the embodiments of the present disclosure are described as above, the embodiments disclosed in the present disclosure are provided not to limit the spirit of the present disclosure but to fully describe the present disclosure. Therefore, the spirit of the present disclosure may include not only each disclosed embodiment but also a combination of the disclosed embodiments. Further, the scope of the present disclosure is not limited to these embodiments. In addition, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A lamp system disposed in a moving object, comprising:
an audio module configured to output a sound;
a light source module including a light source and configured to output an image; and
a control module configured to control, based on a control signal of the lamp system, an output of the light source module and the audio module, the output including the sound and image respectively output from the audio module and the light source module,
wherein, for controlling the output of the light source module and the audio module, the control module is configured to transmit an image signal and an audio signal, which are synchronized with each other, based on the control signal.

2. The lamp system of claim 1, wherein:
the audio module is disposed outside the moving object, and
the lamp system further comprises an external interface configured to transmit the audio signal to the audio module.

3. The lamp system of claim 2, wherein the control module is configured to:
transmit a start command to the audio module before outputting the image signal, and
control the light source module and the audio module to respectively output the image and the sound when an approval command is received from the audio module.

4. The lamp system of claim 1, wherein the light source module further includes:
a lens, and
a piezoelectric element disposed on a surface of the lens and configured to generate vibration based on the audio signal.

5. The lamp system of claim 1, further comprising a memory module configured to store image data and audio data to be output respectively through the light source module and the audio module.

6. The lamp system of claim 5, wherein the image data and the audio data have a same size.

7. The lamp system of claim 5, wherein:
for controlling the output of the light source module and the audio module, the control module is further configured to transmit a plurality of control commands respectively to the light source module and the audio module based on the control signal, and
the plurality of control commands have a same format size.

8. The lamp system of claim 6, wherein the control module is configured to:
control, based on a mapping table, the output of the light source module and the audio module when the image data and the audio data have different sizes, and
control, based on the mapping table, a file including the audio data that is required to be executed simultaneously when executing a file including the image data to be executed sequentially.

9. The lamp system of claim 5, wherein the audio data includes a synchronization signal.

10. The lamp system of claim 1, wherein the audio module further includes a plurality of buffers through which a plurality of sounds is output simultaneously.

11. The lamp system of claim 10, wherein the audio module further includes an amplifier connected to each of the plurality of buffers and configured to change a sound volume of each of the plurality of sounds.

12. The lamp system of claim 10, wherein the audio module is configured to modulate a plurality of sound frequencies for the plurality of sounds to have a plurality of different frequency bands.

13. The lamp system of claim 4, wherein the control module is configured to:
receive temperature data from one of an internal temperature sensor included in the light source module and the moving object; and
control the output of the audio module based on the received temperature data.

14. The lamp system of claim 4, wherein:
the light source module includes a plurality of light sources, and
the control module is configured to increase the output of the audio module based on a number of the light sources that are activated when a number of the light sources that are activated is less than a reference number.

15. The lamp system of claim 13, wherein the control module is configured to increase the output of the audio module when the received temperature data is lower than a reference temperature.

16. The lamp system of any one of claim 13, wherein the audio module further includes a filter configured to correct a frequency of an audio signal input to the audio module.
